(19) United States
(12) Patent Application Publication
(10) Pub. No.: US 2008/0103836 A1
(43) Pub. Date: May 1, 2008

(54) Medical document attachment handling

(75) Inventors: Edward Park, Waltham, MA (US); Anshul Amar, Cambridge, MA (US)

Correspondence Address: PROSKAUER ROSE LLP, ONE INTERNATIONAL PLACE, BOSTON, MA, 02110, US

(73) Assignee: Athenahealth, Inc., Watertown, MA (US)

(21) Appl. No.: 11/590,255

(22) Filed: Oct. 31, 2006

(51) Int. Cl. G06Q 10/00; G06Q 40/00

(52) U.S. Cl. 705/4; 705/2

(57) ABSTRACT

Automating medical practice workflow and billing presents difficulties in many aspects, especially in interacting with the workflow, other healthcare providers, and within the constraints of payor requirements. Disclosed are methods, systems, software and means for automatically providing additional documentation to reconcile a billing claim. In one implementation, there is a computerized method for automatically providing additional documentation to reconcile a billing claim. The method, typically executed in software, includes providing a billing claim based on a patient's workflow, the billing claim typically associated with an a payor such as an insurance provider. The method also involves automatically identifying a document associated with the billing claim based on the patient's workflow. Typically the claim is submitted to the payor and the document is sent to the payor as well, the communications with the payor occurring over a communications network.

### FIELD OF THE INVENTION

The present invention relates generally to workflow in a medical practice management system and more specifically to handling the attachment of medical documents as part of a workflow in a medical practice management system.

### BACKGROUND

Before the advent of networked systems and computers, medical patient workflow and billing was a manual process. Doctors, nurses, receptionists, and others used paper-based records to keep track of what procedures a patient had undergone, what the patient's insurance would and would not cover, and how claims for procedures were to be settled. As computers became more prevalent and widely utilized, many medical practitioners used computers for electronic record keeping and billing statement generation. To fill this niche, many companies began providing software to assist medical practitioners with managing their medical practice. The software and systems provided, however, typically solved only a particular problem, e.g., one company's software focused on billing automation, while another company's software focused on patient management.

Even sophisticated billing management systems do not provide all the functionality necessary for a medical practice to anticipate claim submission problems. After a medical service is performed, typically additional documentation is required by insurance companies before the insurance companies will reimburse a patient or a doctor for a performed medical procedure. Determining which form or document is needed by an insurance company is tedious and difficult because many insurance companies are not always clear in their submission requirements, or the requirements differ from company to company.

### SUMMARY

In one aspect, there is a computerized method for automatically providing additional documentation to reconcile a billing claim. The method, typically executed in software, includes providing a billing claim based on a patient's workflow, the billing claim typically associated with an a payor such as an insurance provider. The method also involves automatically identifying a document associated with the billing claim based on the patient's workflow. Typically the claim and the document are sent to the payor over a communications network.

There is also a system for automatically providing additional documentation to reconcile a billing claim. The system is typically composed of a workflow processing engine, a rules engine, an intelligent transactions relationship module, and an attachment processing module. The workflow processing engine performs one or more automated patient workflow tasks associated with information associated with an event related to a patient. The rules engine, in communication with the workflow processing engine, repeatedly and automatically interacts with the information associated with the event by applying one or more rules in a set of rules to the information in connection with the performance of the one or more of the automated patient workflow tasks. The intelligent transactions relationship module, in communication with the workflow processing engine and a payor server, repeatedly and automatically interacts with the information associated with the event by performing transactions with the payor server in connection with the performance of one or more automated patient workflow tasks. The attachment processing module, in communication with the workflow processing engine and the intelligent transactions relationship module, identifies a document associated with the information associated with the event and interacts with the intelligent transactions relationship module to send the document to the payor server.

In another aspect, there is a computerized means for automatically providing additional documentation to reconcile a billing claim. The means includes means for providing a billing claim based on a patient's workflow, means for automatically identifying a document associated with the billing claim based on the patient's workflow, means for submitting the claim to a payor, and means for sending the document to the payor, the communications with the payor occurring over a communications network.

In another aspect, there is a computer program product, tangibly embodied in an information carrier, such as a computer-readable medium, e.g., memory, or a signal, for automatically providing additional documentation to reconcile a billing claim. The computer program product includes instructions operable to cause a data processing apparatus to provide a billing claim based on a patient's workflow, to identify a document associated with the billing claim based on the patient's workflow, to submit the claim to a payor, and to send the document to the payor, the communications with the payor occurring over a communications network.

These aspects may be realized in various embodiments. In some embodiments a billing message is received from the payor associated with the patient workflow. In some of those embodiments, the document is identified in response to receiving the billing message. In other embodiments, the document is identified in anticipation of receiving the billing message from the payor. In some embodiments, the document is identified based on a prior billing message received from the payor, potentially from a workflow associated with another patient.

In some embodiments, identifying the document involves creating the document from data elements associated with the patient's workflow. In some embodiments, an image is received over a communications network, wherein the image is identified as the necessary document. The communications network may be the communications network providing communications with the payor, or it may be a separate communications network, e.g., between a medical practice management client and a medical practice management server. The document may be received through one of various channels, such as via facsimile, via an electronic message such as email, or via a scanned document. In some embodiments, it is determined that the document is not available and the claim is automatically not submitted to the payor, e.g., the system “waits,” until the document is provided.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 depicts a block diagram of an implementation of a medical practice management system that includes a medical practice client computer, a medical practice management server, and a payor server computer;

FIG. 2A depicts a block diagram of an implementation of the medical practice management server that includes a workflow processing engine, a rules engine, and an intelligent transactions relationship (ITR) module;

FIG. 2B depicts a block diagram of an implementation of the rules engine interacting with several payors including a first payor, a second payor, and a third payor;

FIG. 3A is a block diagram depicting a method for automatically providing additional documentation to reconcile a billing claim; and

FIG. 3B depicts a block diagram of one implementation of a workflow that automatically identifies a required document.

### DETAILED DESCRIPTION

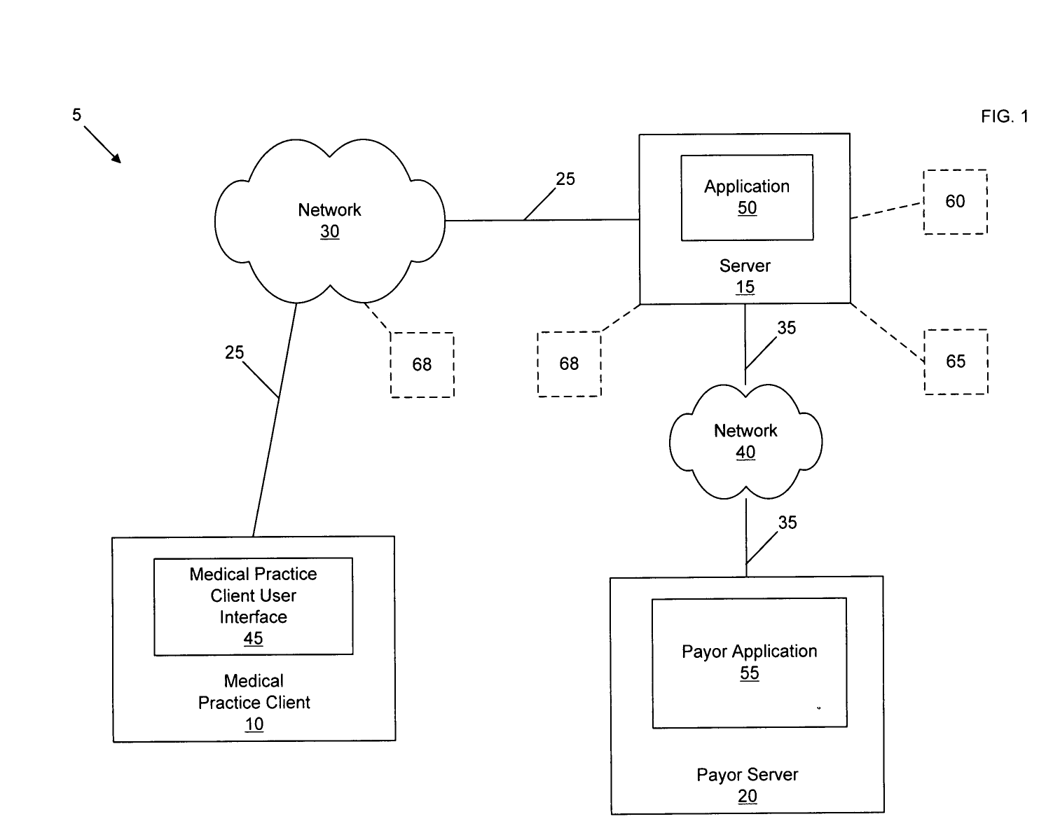

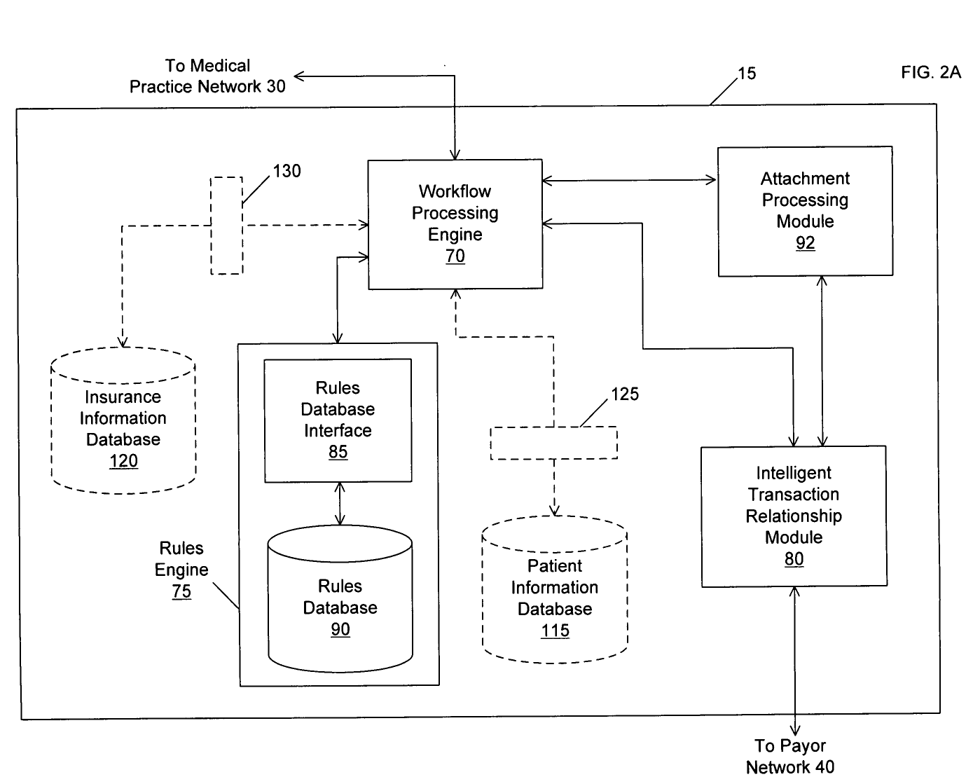

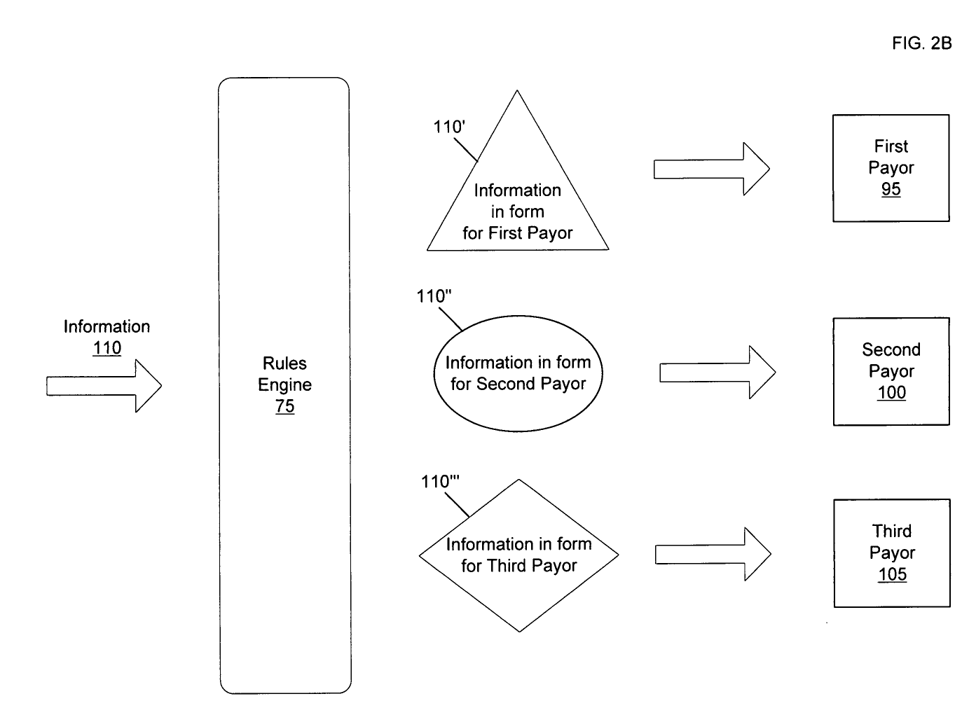

Automating medical practice workflow and billing presents difficulties in many aspects, especially in interacting with the workflow, other healthcare providers, and within the constraints of payor requirements. The invention encompasses several aspects, embodied in varying implementations that address these shortcomings. FIGS. 1, 2A, and 2B and the accompanying description provide an example of one implementation of an architecture in which aspects of the invention operate.

FIG. 1 depicts a block diagram of an implementation of a medical practice management system 5 that includes a medical practice client computer (or medical practice client) 10, a medical practice management server (or server) 15, and a payor server computer (or payor server) 20. The medical practice client 10 is in communication with the medical practice management server 15 over a medical practice client-server communication path 25 and passes through a first communications network (or medical practice client-server network) 30. The medical practice management server 15 is also in communication with the payor server 20 over a payor server communication path 35 and passes through a second communications network (or payor server network) 40. FIG. 1 is an exemplary embodiment intended only to illustrate one implementation of a general architecture of, and not to limit, the invention.

The medical practice client-server network 30 and the payor server network 40 can be a local-area network (LAN), a medium-area network (MAN), or a wide area network (WAN) such as the Internet or the World Wide Web. In one embodiment, the medical practice client-server network 30 (e.g., the medical practice client-server communication path 25) supports secure communications. In a further embodiment, communications occur after a medical care provider's, or user's, password is verified by the medical practice management server 15. Exemplary embodiments of the communication paths 25, 35 include standard telephone lines, LAN or WAN links (e.g., T1, T3, 56 kb, X25), broadband connections (e.g., ISDN, Frame Relay, ATM), and wireless connections. The connections over the communication paths 25, 35 can be established using a variety of communication protocols (e.g., TCP/IP, IPX, SPX, NetBIOS, Ethernet, RS232, and direct asynchronous connections).

The medical practice client 10 can be any personal computer, Windows-based terminal, network computer, wireless device, information appliance, RISC Power PC, X-device, workstation, mini computer, main frame computer, personal digital assistant, or other computing device that has a windows-based desktop, can connect to a network and has sufficient persistent storage for executing a small, display presentation program. Windows-oriented platforms supported by the medical practice client 10 can include, without limitation, Windows 3.X, Windows 95, Windows 98, Windows NT 3.51, Windows NT 4.0, Windows 2000, Windows XP, Windows Vista, Windows CE, Windows Mobile, Mac/OS, OS X, Java, and Unix/Linux. The medical practice client 10 can include a visual display device (e.g., a computer monitor), a data entry device (e.g., a keyboard), persistent or volatile storage (e.g., computer memory) for storing downloaded application programs, a processor, and a pointing device such as a mouse or digitized pen.

The medical practice client 10 includes a medical practice client user interface 45. The interface 45 can be text driven (e.g., DOS) or graphically driven (e.g., Windows). In one embodiment, the medical practice client user interface 45 is a web browser, such as Internet Explorer™ developed by Microsoft Corporation (Redmond, Wash.), to connect to the medical practice client-server network 30. In a further embodiment, the web browser uses the existing Secure Socket Layer (SSL) support, developed by Netscape Corporation, (Mountain View, Calif.) to establish the medical practice client-server network 30 as a secure network.

The medical practice management server 15 and the payor server 20 can be any personal computer. In one embodiment, the medical practice management server 15 hosts one or more applications 50 that the medical practice client 10 can access. Moreover, the payor server 15 can host one or more applications 55 that the medical practice management server 15 can access. In one version, the medical practice management server 15 (and/or the payor server 20) is a member of a server farm, which is a logical group of one or more servers that are administered as a single entity. In the embodiment depicted in FIG. 1, the server farm includes the server 15, a second server 60, and a third server 65 (the latter two shown in shadow). In one embodiment, the medical practice management server is in communication, via the communications network 30, with a fax machine 68 (shown in shadow) or similar device that receives and/or transmits facsimile transmissions. Alternatively, the fax machine 68 can be connected directly to the medical practice management server 15, via, e.g., a serial, parallel and/or Ethernet connection or the like.

In one implementation, a second medical payor server computer (not shown) communicates with the server 15 through the payor server network 40.

Typically, the medical practice client 10 is used by a medical care provider. Examples of the medical care provider include, but are not limited to, medical physicians, medically trained individuals, medical specialists, medical experts, receptionists, and the like. The medical practice client 10 is typically located in a medical practice. In one embodiment, the medical practice is the office of the medical care provider (e.g., a doctor's office), a hospital, other facilities providing medical treatment, and the like. Further, in one embodiment, a payor organization, or payor, uses the payor server 20. Although also referred to below as an insurance company, example embodiments of a payor organization also include, but are not limited to, health maintenance organizations (HMOs). More specifically, examples of payor organizations include, without limitation, Century Health and Benefits, HMO Blue, Harvard Pilgrim Health Care, MassHealth, Medicare, Neighborhood Health Plan, Tufts Associated Health Plan, United Healthcare, and the like.

Beneficially, many medical practices may utilize the same medical practice server 15 via medical practice clients 10 located at the respective medical practice locations. In some implementations providing service for multiple medical practices is achieved by providing data storage (not shown), e.g., databases and/or database tables, file systems, and the like, for each practice. For example, Dr. Smith, an internist, may utilize the medical practice management system 5 and Dr. Jones, an oral surgeon, who is not affiliated or associated with Dr. Smith, may also use the medical practice management system 5. Information associated with Dr. Smith's practice is stored in one practice database, while information associated with Dr. Jones' practice is stored in another database. In some implementations, there is one database and the information associated with the respective doctors' practice is stored in separate tables. In other implementations the information associated with the respective doctors' practices is stored as different rows in the same database table.

Providing the system 5 to multiple practices is mutually advantageous to the participating medical practices and the implementer of the system 5. The medical practices can communicate between each other via the server 15 and can modify the patient workflow of a patient common to each practice. Continuing the previous example, by both using the medical practice management system 5, Doctors Smith and Jones may easily refer patients between themselves, or approve procedures recommended by the other, etc. The system 5 is benefited because configuring the server 15 to interact with a payor for one medical provider obviates the need to configure the server 15 to interact with the payor for a second provider because the configuration is already done. Continuing the prior example, if in configuring the system 5 for Dr. Smith's practice, the medical practice management system 5 was configured to interact with Blue Cross/Blue Shield of Massachusetts (BCBSMA), if Dr. Jones also accepts BCBSMA, the system 5 does not need to be configured a second time. Rather, when configuring the server 15 for Dr. Jones' practice, only that Dr. Jones accepts BCBSMA need be provided. Beneficially, the more medical practices that use the same payor, the greater the return on investment in initially configuring the system to interact with the payor.

Additionally or alternatively, in some implementations, the medical practice management system 5 is operated as a subscription-based model, with pricing and/or support levels determined by a contract between the medical practice and the implementer and/or operator of the medical practice server 15. Some embodiments provide the full functionality of the system 5, while other embodiments provide only limited functionality to certain medical practices, e.g., only batch processing of claims instead of real-time claim processing, twenty four-hour daily support versus sixteen hour, five days a week support, or other functional limitations. In some embodiments, only a small amount of functionality is provided to those medical practices that do not subscribe to the medical practice management system service. Medical practices that subscribe to the service are typically referred to as “group practices.” Medical practices that do not subscribe to the service are usually referred to as “non-group practices.” Non-group practices may, for example, see patient records upon approval but cannot affect the patient workflow, or, where messaging capabilities are provided, the non-group medical practice may leave messages for group practices. Other versions of the system provide mixed levels of service, or provide different levels of service to both group and non-group medical practices that are using the system 5, e.g., in some versions non-group practices make changes to a patient workflow.

Referring to FIG. 2A, the medical practice management server 15 includes a workflow processing engine 70, a rules engine 75, and an intelligent transactions relationship (ITR) module 80. In one embodiment, the rules engine 75 includes a rules database interface 85 and a rules database 90. In one embodiment, the workflow processing engine 70, the rules engine 75 and/or the ITR module 80 are software modules located within the medical practice management server 15. In another embodiment, one or more of the engines 70, 75 and/or the ITR module 80 are externally located from the server 15 and communicate with the server 15.

In one embodiment, the workflow processing engine 70 is a software application that controls and manages the features and functions of the medical practice management system 5. The workflow processing engine 70 and the medical practice client 10 communicate over the medical practice client-server network 30. In operation, the medical practice client 10 transmits a medical care provider request containing information to the medical practice management server 15 using, for example, a common gateway interface (CGI) request. For example, when registering a new patient, a medical care provider operating the medical practice client 15 enters the relevant patient information on a patient registration template that the workflow processing engine 70 delivered to the medical practice client user interface 45. Additionally, as tasks such as patient check-in and check-out, as well as medical procedure tasks are performed, the workflow engine monitors the patient's workflow and provides the appropriate sequence of steps for the management of the patient's care, e.g., the patient cannot be checked out before the patient is checked in. The workflow tasks are stored on the medical practice management server 15 for later review, e.g., in memory, in a database, or the like.

The workflow processing engine 70 also checks the structure and composition of information entered by a medical care provider at the medical practice client 10 to ensure that the information is correct (i.e., structure and/or composition). Examples of information entered by a medical care provider at the medical practice client 10 include the patient's address, phone number, medical history, insurance information, diagnosis and procedure codes, and the like.

The workflow processing engine 70 is additionally in communication with the rules engine 75. The rules engine 75 enables real-time application of “rules” stored in the rules database 90. A rule is coded logic that evaluates data and then performs an action.

The rules engine 75 can access and update information stored in the rules database 90 using the rules database interface 85. Although not shown in FIG. 2, in another embodiment the rules database interface 85 is a software layer internal to the workflow processing engine 70. Typically, the rules database interface 85 is implemented as an application program interface, a Component Object Model (COM) object, an Enterprise Java Bean, or the like.

The rules database 90 and/or the rules database interface 85 may be written in a structured query language, such as SQL. In one embodiment, the rules database interface 85 uses a Lightweight Directory Access Protocol (LDAP) to access information in the rules database 90. Additionally or alternatively, the rules database 90 can be external to the server 15 or may be internally situated in the server 15.

The rules database 90 includes insurance company rules that define the appropriate format and content of clinical and claim information that the payor server 20 processes. In one embodiment, the rules are subdivided into various classes. For example, the rules are divided into rules that have universal applicability to all claims for a specified payor, rules that apply only to one or more specific insurance packages from among the variety of insurance packages that the payor offers to medical care providers, and rules that apply only to specific medical care providers who provide care under one or more specific insurance packages.

Typically, a trigger invokes the application of a particular rule. For example, the submission of an insurance claim for a first payor could invoke the rules engine 75 to apply particular formatting rules associated with the first payor to format the claim to the first payor's specification. Typically rules are checked and applied in real-time.

To ensure that the rules database 90 contains current rules, the rules database 90 is frequently updated. In one embodiment, individual payors transmit rule updates/creations to the medical practice management server 15 via their payor server 20. Rule specialists review the rules transmitted by the payor server 20 and subsequently update the rules database 90. In one embodiment, the rules specialist performs any and all updates to the rules database 90. Alternatively, the updating of the rules database 90 can be automated upon receipt of a rule transmission from the payor server 20 or the medical practice client 10.

Additionally, a medical care provider can submit information to the medical practice management server 15 for subsequent update of the rules database 90 based on the medical care provider's experience with one or more payors. In another embodiment, the rules database 90 is updated with the server's historical analysis of previously submitted claims, especially those that were denied, to identify the reasons for denial. The historical analysis of previously submitted claims can facilitate the development of new rules for the rules database 90.

In some embodiments the workflow processing engine 70, rules engine 75, and the ITR 80, interact together to process any additional documentation that may be required to reconcile a claim. In some embodiments, however, this functionality is embodied in a separate attachment processing module 92. The attachment processing module is typically software that executes on the medical practice management server 15 that interacts with the workflow processing engine 70, rules database 75, and/or ITR 80, to improve claim submissions. The attachment processing module responds to rejected claims to determine if additional documentation is required by the payor 20 to reconcile the claim and if so, the attachment processing module iterates through the workflow tasks of the workflow processing engine 70 to retrieve the requested document and submits the document to the payor 20.

Referring to FIG. 2B, the rules engine 75 may interact with several payors (and therefore several payor servers 20), such as a first payor 95, a second payor 100, and a third payor 105. The rules engine 75 receives information 110, such as an insurance claim, from the workflow processing engine 70. In one embodiment, the rules engine 75 determines the payor 95, 100, 105 that the information 110 will be submitted by, for instance, searching the information 110 for a payor field. Once the rules engine 75 determines the receiving payor 95, 100, 105, the rules engine 75 applies the appropriate rules that are stored in the rules database 90 for the particular payor 95, 100, 105 to the information 110.

For example, the rules engine 75 applies the rules to the information 110 for the first payor 95 and subsequently transforms the originally received information 110 into first information 110′ having a form acceptable to the first payor 95. Likewise, the rules engine 75 applies the rules to the information 110 for the second payor 100 and subsequently transforms the originally received information 110 into second information 110″ having a form acceptable to the second payor 100. The rules engine 75 performs the same process to the information 110 to format the information 110 into third information 110′″ acceptable to the third payor 105.

Referring again to FIG. 2A, in one embodiment the medical practice management server 15 also includes a patient information database 115 (shown in shadow) and an insurance information database 120 (shown in shadow). The workflow processing engine 70 stores all of the information associated with a registered patient in the patient information database 115. The patient information database 115 stores information associated with existing patients of the medical practice. The information can include, for example, the patient's address, phone number, zip code, height, weight,.allergies, previous doctor(s), procedures performed by this medical care provider, procedures performed by other medical care providers, and the like. In one embodiment, the medical practice management server 15 indexes the patient information stored in the patient information database 115 by the patient name. In another embodiment, the server 15 indexes the patient information stored in the patient information database 115 with a patient identifier. The patient identifier can be a random number, a predetermined integer (such as a patient counter), the patient's zip code, the patient's phone number, and the like. The workflow processing engine 70 typically accesses the patient information database 115 using a patient information database interface 125.

Similarly, the workflow processing engine 70 can store all of the information associated with an insurance company in the insurance information database 120, such as the insurance company's address, the amount of insurance coverage for a particular patient, and the like. Moreover, the workflow processing engine 70 can access the insurance information database 120 using an insurance information database interface 130.

In operation, as the workflow processing engine 70 receives information from the medical practice client 10, the workflow processing engine 70 determines on a real time basis whether all of the required information has been provided and whether the information is in the correct format. In the event that there is a deficiency in the information, the workflow processing engine 70 alerts the medical care provider (e.g., receptionist), or user, for additional information. Alternatively, the workflow processing engine 70 corrects the defect.

For instance, if the rules engine 75 contains a rule about member identification formatting for a particular payor, the rules engine 75 determines the rule in the rules database 90 and communicates the information to the workflow processing engine 70. The workflow processing engine 70 communicates this information to the medical practice client 10 when a medical care provider (e.g., receptionist) is registering a patient. If the medical care provider (e.g., receptionist) errs, the medical practice management server 15 alerts the medical care provider (e.g., with a warning message) to correct the error. This enables medical care providers to generate claims with no errors (i.e., referred to as clean claims) for the mutual benefit of the medical care provider and the payor. Additionally, the medical care providers can obtain the information associated with an alert while the patient is physically present, e.g., while the patient is still at the hospital or medical service provider during their procedure or before checking out.

The workflow processing engine 70 is also in communication with the ITR module 80. The ITR module 80 executes transactions sent to and received from the payor server 20. Thus, the majority of provider/payor transactions can be accomplished electronically, with little or no human intervention. Examples of these transactions include, without limitation, claim submittals, claim receipt acknowledgements, claim status checks, patient eligibility determinations, authorization and referral requests and grants, and remittance advice. For example, a predetermined number of days before a scheduled patient visit, the ITR module 80 automatically checks patient eligibility with the applicable payor identified during the patient registration process. After a patient visit and the completion of the claim template, the claim is submitted to the payor server 20 via the ITR module 80.

In one embodiment, upon receipt of an insurance claim, the payor 20 transmits a confirmation back to the medical practice management server 15. Later, on a schedule determined by the medical care provider, the ITR module 80 checks the claim status and notifies the medical practice client 10 accordingly. After the ITR module 80 analyzes the claim and generates remittance advice, the ITR module 80 parses the electronic payment and allocates the payment among the individual charge line items for the services provided. Once the medical care provider approves the allocations, the payments are posted to the provider's accounts.

Although described above as individual components, the engines 70, 75 and the ITR module 80 can be combined into one component or any number of components. Similarly, the databases, 90, 115, 120 could also be combined into one database and can be external or internal to the server 15. In other embodiments, the patient information and/or the insurance information is stored on a disk, such as a compact disk or a ZipDrive, developed by Iomega Corporation (Roy, Utah).

The medical practice management system 5 performs operations in response to an event related to a patient. Although a patient visit is used hereinafter as the event, the event can also be an emergency phone call to the medical provider, an emergency visit to the medical provider, a “virtual” visit to the medical practice client 10 (i.e., on-line communications with the medical practice client 10, such as over the Internet), and the like.

The medical practice management server 15 receives information associated with the event related to a patient from the medical practice client 10 and/or from the payor server 18 over the respective network 30, 40. The medical practice management server 15 performs one or more tasks associated with the event and then uses the information associated with the event to create an insurance claim after the completion of the task(s). An example of the information associated with the event is the patient information. The medical practice management server 15 automatically and repeatedly interacts with the information associated with the event in connection with the performed tasks by applying one or more rules in a set of rules and/or by performing transactions with the payor server 20.

Incorporating new technology into an existing medical practice is often difficult. Documents associated with a patient, for example, a patient's medical charts, are typically provided physically, i.e., as “hard copies,” when a patient is being serviced by multiple healthcare providers, e.g., after being referred to a specialist by a primary care physician, or when a hospital receives a patient's charts from a family doctor. In some cases, a patient's documents, charts, and medical history are stored electronically by a healthcare provider. These documents can then be printed out and mailed to another healthcare provider if necessary. Typically if charts, e.g., images or faxes, are stored electronically they are beneficially can be transmitted or shared with other healthcare providers. As described herein, this is especially simple when healthcare providers share patients and allow each other access to patient's records stored on the medical practice management server 15.

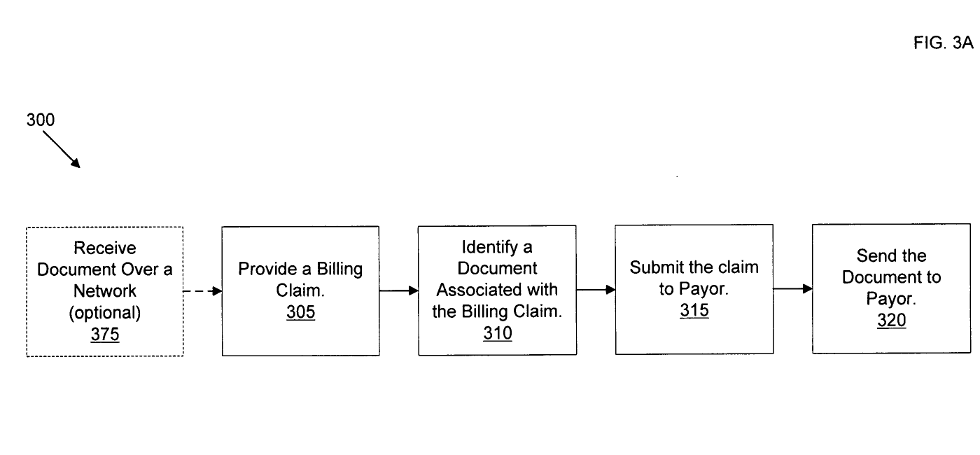

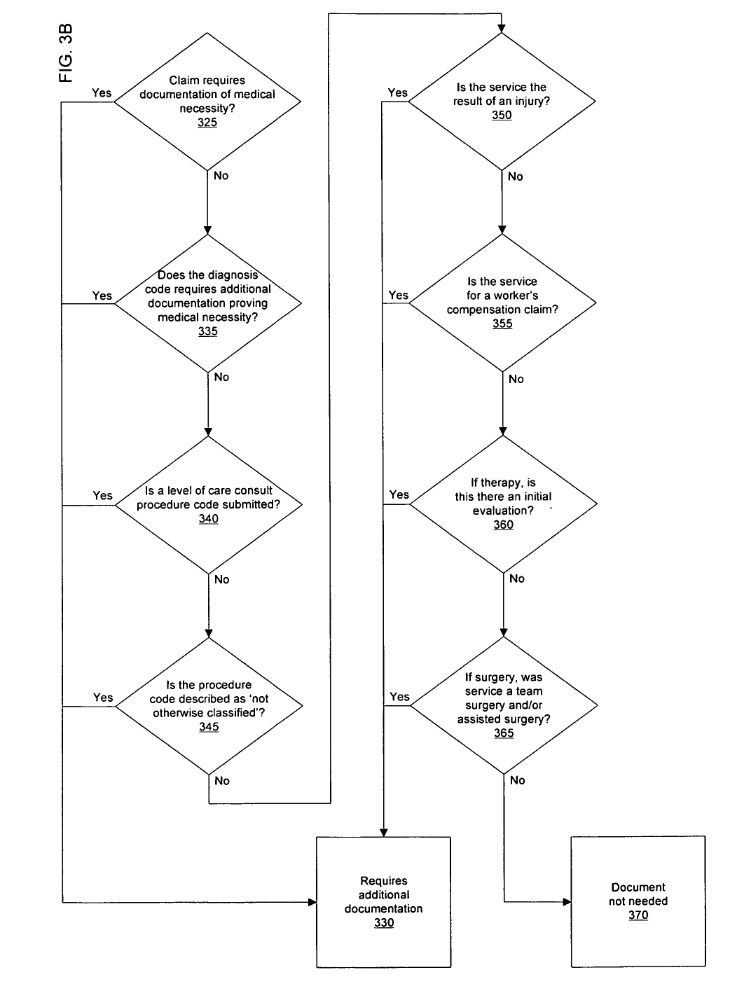

FIG. 3A is a block diagram depicting a method 300 for automatically providing additional documentation to reconcile a billing claim. The method involves providing 305 a billing claim based on the workflow surrounding a patient's visit, automatically identifying 310 a document associated with the billing claim based on the patient's workflow, submitting 315 the claim to a payor, and sending 320 that document to a payor, typically over a communications network. The method is typically carried out by software executing on the medical practice management server 15 such as the one described herein. The billing claim is generated typically as part of a patient workflow, e.g., the patient sees a healthcare provider and has a procedure performed, and an insurance claim based on the patient's visit is created via the workflow processing engine 70, the rules engine 75, and/or the ITR 80 of the medical practice management server 15. The billing claim may also come from a vendor of the healthcare provider. For example, a blood laboratory may bill a healthcare provider for blood work done for a patient rather than the blood laboratory creating a separate claim to submit to the patient's insurance company. The healthcare provider then creates the claim based on all the services performed by the healthcare provider and its vendors and submits a unified claim to the payor. Based on what service was provided to the patient (as part of the patient workflow) a document necessary for the claim submission process is automatically identified 310, e.g., with little to no human intervention. Automatically identifying 310 the document is typically based on one or more scenarios: in response to an error in this workflow, in anticipation of an error in this workflow, and/or in response to an error in a workflow of another patient.

FIG. 3B depicts a block diagram of one implementation of a workflow that automatically identifies a required document. Typically medical care providers are required to submit supporting documentation when a procedure or service performed is excluded under the patient member's benefit plan as not medically necessary. Often payors request documentation to support medical necessity. Examples of such documents are operative reports, letters of medical necessity, consultant reports, and the like. In one implementation, the identifying workflow determines 325, based on rules in the rules database 90 and the rules engine 75, if the claim requires a document of medical necessity. If the claim does require a document stating the medical necessity of the procedure, the system stores 330 that the claim and/or workflow require additional documentation, e.g., in memory, as a value in the rules database, and/or in the workflow associated with the task. Beneficially, storing that certain procedures require additional documentation allows the system to “learn” over time and increase patient workflow and claim submission efficiency since claim errors are anticipated based not just at the claim submission point, but at the patient workflow level as well, e.g., patient check-in/check-out.

In some embodiments, medical care providers are required to submit supporting documentation when the diagnosis code selected by the provider does not support the medical necessity of the procedure or service. The server 15 determines 335 if the diagnosis code is a code that requires additional documentation to support the medical necessity. If the code does not, then the server 15 determines 330 that additional documentation is required.

In some implementations, medical care providers are required to submit supporting documentation when a level of care consult procedure code e.g., 99244 or 99245, is submitted on the claim to support code selection. The server 15 determines 340 if the level of care consult code is submitted to support the code selection. If the code has been submitted to support code selection, the server 15 stores 330 that additional documentation is required. In some versions, medical care providers are required to submit supporting documentation when the procedure code selected is described by the American Medial Association's current procedure terminology as “not otherwise classified” or “NOC.” The server 15 determines 345 if the claim is not otherwise classified and then stores 330 that the claim requires additional documentation.

In some implementations, additional documentation is required based on the cause of the care. For example, in some embodiments, medical care providers are required to submit supporting documentation when submitting claims with diagnosis codes that imply the service was the result of an injury or are part of a worker's compensation claim. The server 15 determines 350 if the service is the result of an injury and if so, stores 330 that additional documentation is required. The server 15 also determines 355 if the claim is related to a worker's compensation claim and if so, stores 330 that additional documentation is required.

In some versions, the need for additional documentation is based on the care provided itself. For example, therapy providers, e.g., physical therapy, occupational therapy, and/or speech therapy, may be required to submit initial evaluations and treatment plans with therapy claims. Additionally, if the service is a surgery and involved the services of more than one provider, e.g., a co-surgery, a team surgery and/or assistant at surgery, payors often require supporting documentation to support the need for a team approach and/or assistant at surgery. The server 15 accounts for these by determining, based on the care provided, if additional supporting documentation is required. For example, if therapy, the server 15 determines 360 if the service is an initial evaluation or is one that requires the submission of an initial evaluation, e.g., a change in diagnosis. Similarly, if the service provided was a surgery, the server 15 determines 365 if the service was a team surgery, assisted surgery or the like and if so, the server 15 stores 330 that additional documentation is required in either case. If none of the scenarios are satisfied, the server 15 stores 370 that additional documentation is not needed. These scenarios are examples and not limiting; many other similar rules are contemplated.

Referring back to FIG. 3A, in some embodiments, the claim is submitted 315 (without the necessary document) to the payor as described with respect to FIG. 2B. The payor rejects the claim and provides an error message describing one or more problems with the claim. Payor remittance transactions typically follow conventions established by American National Standards Institute (ANSI) as part of ANSI 835. The error messages often include particular error codes that identify the deficiencies in the submitted claim, the error codes themselves having a corresponding explanation. For example, error code M25 has the following explanation: “Payment has been adjusted because the information furnished does not substantiate the need for this level of service. If you believe the service should have been fully covered as billed, or if you did not know and could not reasonably have been expected to know that we would not pay for this level of service, or if you notified the patient in writing in advance that we would not pay for this level of service and he/she agreed in writing to pay, ask us to review your claim within 120 days of the date of this notice. If you do not request a appeal, we will, upon application from the patient, reimburse him/her for the amount you have collected from him/her in excess of any deductible and coinsurance amounts. We will recover the reimbursement from you as an overpayment. Note: (Modified Oct. 1, 2002, Jun. 30, 2003, Aug. 1, 2005).”

Other error codes include, but are not limited to:
M29 “Missing operative report. Note: (Modified Feb. 28, 2003) Related to N233”
M30 “Missing pathology report. Note: (Modified Aug. 1, 2004, Feb. 28, 2003) Related to N236.”
M31 “Missing radiology report. Note: (Modified Aug. 1, 2004, Feb. 28, 2003) Related to N240.”
M35 “Missing/incomplete/invalid pre-operative photos or visual field results. Note: (Deactivated eff. Feb. 5, 2005) Consider using N178.”
M42 “The medical necessity form must be personally signed by the attending physician.”
M63 “We do not pay for more than one of these on the same day. Note: (Deactivated eff. Jan. 31, 2004) Consider using M86.”
M69 “Paid at the regular rate as you did not submit documentation to justify the modified procedure code. Note: (Modified Feb. 1, 2004).”
N95 “This provider type/provider specialty may not bill this service. Note: (New code Jul. 31, 2001, Modified Feb. 28, 2003).”
N102 “This claim has been denied without reviewing the medical record because the requested records were not received or were not received timely. Note: (New code Oct. 31, 2001).”
N146 “Missing screening document. Note: (Modified Aug. 1, 2004) Related to N243.”
N233 “Incomplete/invalid operative report. Note: (New Code Aug. 1, 2004).”

Upon receiving one of these codes as part of the transaction with the payor, the server 15 then determines what the error was and what must be done to satisfy the claim.

In one scenario, the claim requires the submission of additional documentation such as an X-ray or Magnetic Resonance Image (MRI) image. For example, if the server 15 receives a message, e.g., M35 above, the server 15 determines that pre-operative photos were not submitted to the payor and need to be submitted. The medical practice management server 15, via the workflow engine 70, then reviews the steps performed during the patient workflow that resulted in the claim generation, e.g., iterates through the workflow tasks that have been performed, and determines that during the step prior to the submission of the claim an image of the patient's X-ray was stored in the patient's record in the Patient Information Database 115, e.g., by determining if a document was uploaded via an HTML form and saved. If the image saved is of the type necessary, e.g., a property of the saved image is stored in the database such as isXray or isMRI, then the image is retrieved from the database and submitted to the payor servers 20.

In some embodiments, when the medical practice management server 15 receives an error message from a failed claim, a rule is created in the rules database 90 requiring the medical practice management server 15 to submit the appropriate document the next time a claim is submitted, e.g., the error code is interpreted (for example “mapped to”) as “the insurance company requires an X-ray for that claim”, so a rule such as “requiresXray” is added for that particular claim type. Using the previous example, if the patient regularly has chest X-rays to monitor an illness such as lung cancer, on the next visit of the patient, before the claim is submitted to the payor, the medical practice management system processes the newly-created requiresXray rule and the X-ray uploaded to the medical practice management server 15 is attached to and/or included with the claim before the claim is submitted to the payor server. Beneficially the system now anticipates the requirements of the payor without manual intervention from a human user.

Beneficially, in some embodiments, the rule is applicable to all patients submitting that claim to that payor, even if the second patient has not had that treatment performed before. For example, if a second patient is starting a similar treatment plan, or is submitting to the payor the same claim as the first patient, the medical practice management server 15 processes the “requiresXray” rule, anticipates the requirement of the payor, and attaches the X-ray for the second patient to the second patient's claim, even though the second patient has never had the procedure performed before.

As described above, in some embodiments the document required by the payor is an image. The image is typically an image such as an X-ray or a MRI, though the image may be any chart or document associated with the patient's medical records. Additionally or alternatively, the image could be an approval by a doctor for a treatment plan or a doctor's prescription for a patient that is viewable by a pharmacist.

In some embodiments, the image is a consent or waiver form that a patient needs to sign. In some of these embodiments, a kiosk located in the medical care provider's facility serves as the medical practice client 10 and a patient interacts with the system 5 or the server 15 via the screen of the kiosk. Alternatively, the medical practice client 10 may be embodied as a web browser that has access to a web portal, the web portal providing access to the medical practice management system 5 or the medical practice management server 15. The patient accesses the portal from outside the medical care provider's office, e.g., accessed from the patient's home computer. In these embodiments, e.g., the kiosk or the web portal, patients can electronically sign consent forms or waiver forms through the annotation process. Allowing patients to access the system and sign consent and waiver forms makes treatment procedures more efficient because a patient no longer needs to be physically at the medical provider's location to sign necessary documents, nor do they have to wait to receive the documents in the postal mail, sign them, and mail them back to the medical care provider facility. This increases efficiency and speeds up claims processing.

In some embodiments, the document is received 375 by the medical practice management server 15 via a communications network 30. The document may be received before or after the billing claim has been generated and/or before or after the claim has been submitted. In some versions the document is received by the medical practice management server 15 via a LAN, MAN, WAN, the Internet, over a phone line, or the like. In other embodiments the document is scanned into electronic format via a scanner in signal communication with the medical practice management server 15. In other embodiments the document is received via a facsimile machine 68 in communication with the medical practice management server 15. In some embodiments the document is communicated by the fax machine via the communications network 30. In other embodiments the document is communicated to the medical practice management server via a direct data connection, e.g., Ethernet cable, or parallel or serial connection. Additionally or alternatively, the medical practice management system 5, in some versions, employs software that converts a received facsimile into a document file. The software, in some embodiments, is executed on the medical practice management server 15. In other embodiments the software executes on a server (not shown) that is signally located on the communications network 30 between the fax machine and the medical practice management server 15. In any of these scenarios, the document may be received and/or stored in virtually any format, such as an image format, e.g., a CompuServe's Graphics Interchange Format file (GIF), a file of the type defined by the Joint Photographic Experts Group (JPEG), a Tagged Image File Format file (TIFF), a Portable Network Graphic file (PNG), Portable Document Format (PDF), or the like.

In some embodiments the document required by the payor is not an image such as an X-ray or MRI but is instead a document summarizing various aspects of the patient's treatment plan, e.g., when doses of medicine were administered, medical history, e.g., patient's prior treatments, or legal documentation, e.g., consent forms. Other examples of documents expected by a payor include, but are not limited to, surgical notes accompanying a surgery, letters of medical necessity, court orders, Physician'treatment plan, a consultant report, an accident report, a pathology report, radiology reports, anesthesia records, patient advanced beneficiary notice (ABN), consent form, and/or sterilization forms.

This summary document is compiled from data elements stored in the patient information database 115 obtained from prior steps of the patient workflow. Typically this involves iterating over the workflow tasks performed by the workflow processing engine 70 during the patient workflow and querying the tables of the patient information database 115 for the information needed.

In some embodiments, if the document identified 310 is not available, the ITR 80 module will automatically hold a claim, e.g., not submit 315 the claim to a payor, until the required document is provided. Beneficially this reduces the number of claims that are rejected by payors because incomplete claims are avoided.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or is operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A computerized method for automatically providing additional documentation to reconcile a billing claim comprising:
providing a billing claim based on a first patient workflow;
automatically identifying a document associated with the billing claim based on the first patient workflow;
submitting the claim to a payor over a first communications network; and
sending the document to the payor over the first communications network.

2. The method of claim 1 further comprising receiving a billing message from the payor associated with the first patient workflow.

3. The method of claim 2 wherein the identifying step is performed in response to receiving the billing message.

4. The method of claim 1 wherein the identifying step is performed in anticipation of receiving a billing message from the payor.

5. The method of claim 1 wherein the document is identified based on a prior billing message received from the payor.

6. The method of claim 5 wherein the prior billing message received from the payor is associated with a second patient workflow.

7. The method of claim 1 wherein the payor associated with the billing claim is an insurance provider.

8. The method of claim 1 wherein identifying the document comprises creating the document from data elements associated with the first patient workflow.

9. The method of claim 1 further comprising receiving an image over a second communications network.

10. The method of claim 9 wherein identifying the document comprises determining the image is the document.

11. The method of claim 10 wherein the image is received via facsimile.

12. The method of claim 10 wherein the image is received via an electronic message.

13. The method of claim 12 wherein the electronic message is an electronic claim.

14. The method of claim 10 wherein the image is a scanned document.

15. The method of claim 1 further comprising determining that the document is not available and automatically waiting to submit the claim to the payor until the document is provided.

16. A system for automatically providing additional documentation to reconcile a billing claim comprising:
a workflow processing engine performing one or more automated patient workflow tasks associated with information associated with an event related to a patient,
a rules engine in communication with the workflow processing engine for repeatedly and automatically interacting with the information associated with the event by applying one or more rules in a set of rules to the information in connection with the performance of the one or more of the automated patient workflow tasks;
an intelligent transactions relationship module in communication with the workflow processing engine and a payor server for repeatedly and automatically interacting with the information associated with the event by performing transactions with the payor server in connection with the performance of one or more automated patient workflow tasks; and
an attachment processing module in communication with the workflow processing engine and the intelligent transactions relationship module for identifying a document associated with the information associated with the event and for interacting with the intelligent transactions relationship module to send the document to the payor server.

17. The system of claim 16 wherein the attachment processing module is configured to receive a billing message from the payor server associated with the event.

18. The system of claim 17 wherein the attachment processing module is further configured to identify the document in response to receiving the billing message from the payor server.

19. The system of claim 16 wherein the attachment processing module is configured to identify the document in anticipation of receiving a billing message from the payor server.

20. The system of claim 16 wherein the attachment processing module is configured to identify the document based on a prior billing message received from the payor server.

21. A computerized means for automatically providing additional documentation to reconcile a billing claim comprising:
means for providing a billing claim based on a patient workflow;
means for automatically identifying a document associated with the billing claim based on the patient workflow;
means for submitting the claim to a payor over a communications network; and
means for sending the document to the payor over the communications network.

22. A computer program product, tangibly embodied in an information carrier, for automatically providing additional documentation to reconcile a billing claim, the computer program product including instructions being operable to cause data processing apparatus to:
provide a billing claim based on a patient workflow;
identify a document associated with the billing claim based on the patient workflow;
submit the claim to a payor; and
send the document to the payor.
